(19) United States
(12) Patent Application Publication
(10) Pub. No.: US 2012/0191964 A1
(43) Pub. Date: Jul. 26, 2012

(54) METHODS OF BOOTING INFORMATION HANDLING SYSTEMS AND INFORMATION HANDLING SYSTEMS PERFORMING THE SAME

(76) Inventors: JONG-MIN LEE, Seoul (KR); Hyung-Chan Choi, Seoul (KR); Hee-Joo Choi, Hwaseong-si (KR); Seung-Man Shin, Suwon-si (KR)

(21) Appl. No.: 13/314,666

(22) Filed: Dec. 8, 2011

(30) Foreign Application Priority Data
Jan. 25, 2011 (KR) 10-2011-0007119

(51) Int. Cl. G06F 9/00; G06F 12/00

(52) U.S. Cl. 713/2

(57) ABSTRACT

A method of booting an information handling system including a volatile memory device to be selectively tested during a booting operation, the method comprising a step of reading current system configuration information from the information handling system, a step of comparing the current system configuration information with corresponding prestored system configuration information in a nonvolatile memory device, and a step of selectively performing a test for the volatile memory device according to a result of the comparison.

### CROSS-REFERENCE TO RELATED APPLICATIONS

This U.S. non-provisional application claims the benefit of priority under 35 U.S.C. §119 to Korean Patent Application No. 2011-0007119 filed on Jan. 25, 2011 in the Korean Intellectual Property Office (KIPO), the entire content of which is incorporated herein by reference in its entirety.

### TECHNICAL FIELD

The present inventive concept relates to methods of booting information handling systems and information handling systems performing the same. More particularly, the present inventive concept relates to reduction of a booting time by selectively testing a volatile memory system in an information handling system.

### DISCUSSION OF RELATED ART

The increase in complexity of information handling systems has resulted in corresponding increase of a booting time for the information handling systems. To the contrary, customers to information handling systems have demanded for information handling systems that they can activate and use as soon as possible irrespective of the extent of the system complexity. Accordingly, demands for reducing a booting time is required.

### SUMMARY

In an embodiment of the present inventive concept, a method of booting an information handling system including a volatile memory device to be selectively tested during a booting operation, the method comprising a step of reading current system configuration information from the information handling system, a step of comparing the current system configuration information with corresponding prestored system configuration information in a nonvolatile memory device, and a step of selectively performing a test for the volatile memory device according to a result of the comparison.

In a further embodiment, the information handling system includes a processor, a board and the volatile memory device as a system configuration. The volatile memory device is a memory module of a plurality of dynamic random access memories (DRAMs). Alternatively, the volatile memory device is one or more mobile dynamic random access memory (DRAM). The memory module includes the nonvolatile memory device of a serial presence detect (SPD) memory. Alternatively, the nonvolatile memory device is a basic input output system (BIOS) memory device.

In a further embodiment, the step of reading current system configuration information comprises a step of extracting a current serial number of a processor from the processor, a step of extracting a current serial number of the board from a BIOS memory device, and a step of extracting a current serial number of the memory module from the serial presence detect (SPD) memory device.

In a further embodiment, the step of selectively performing a test comprises a step of, if the current system configuration information does not match the prestored system configuration information, performing a test for checking memory cells of the volatile memory device, storing test results of the step of performing a test for checking memory cells in the nonvolatile memory device, and storing the current system configuration information in the nonvolatile memory device. The step of performing a test for checking memory cells is performed by built-in self-test logic. The step of selectively performing a test further comprises a step of training for optimizing signal integrity of channels connected to the volatile memory device. The step of selectively performing a test further comprises a step of applying test results prestored in the nonvolatile memory device to the information handling system without performing the test for checking memory cells and training for optimizing signal integrity of channels if the current system configuration information matches the corresponding stored system configuration information.

In another embodiment of the present inventive concept, a method of booting an information handling system including a volatile memory device comprises a step of monitoring a triggering condition for testing the volatile memory device. The method further comprises a step of performing a test for checking a failed memory cell in the volatile memory device and training for optimizing signal integrity of channels connected to the volatile memory device if the triggering condition is detected. The method further comprises a step of skipping the test for checking a failed memory cell and the training for optimizing signal integrity of channels if the triggering condition is not detected,.

In a further embodiment, the triggering condition is one or more of a system configuration change, a predetermined amount of change in operating temperature, abnormal termination in a previous operation, a predetermined consecutive number of booting operations without testing the volatile memory device. The system configuration change is any change of serial numbers of a processor, a board and a volatile memory device at a current booting operation from those stored in a nonvolatile memory device. The change of operating temperature is a predetermined amount of difference between operating temperature stored in a nonvolatile memory device and that of current booting operation. The abnormal termination is detected by checking a termination flag to indicate how the information handling system terminated in a previous operation.

In a further embodiment, the method further comprises a step of comparing a booting count with the predetermined number of consecutive booting operations, and a step of increasing the booting count by 1 at each time the information handling system is booted without testing the volatile memory device during previous booting operations.

In another embodiment of the present inventive concept, an information handling system comprises a board, a processor mounted on the board, a volatile memory device mounted on the board, and coupled to the processor, and a nonvolatile memory device configured to store serial numbers of the board, the processor and the volatile memory device, wherein the processor is configured to monitor a triggering condition for testing the volatile memory device, and is configured to selectively perform a test for checking memory cells in the volatile memory device and training for optimizing signal integrity of channels connected between the volatile memory device and the processor.

In a further embodiment, the triggering condition is one or more of a system configuration change, a predetermined amount of change in operating temperature, abnormal termination in a previous operation, a predetermined consecutive number of booting operations without testing the volatile memory device. The system configuration change is any change of the serial numbers of the processor, the board and the volatile memory device at a current booting operation from those stored in the nonvolatile memory device.

### BRIEF DESCRIPTION OF THE DRAWINGS

Illustrative, non-limiting example embodiments will be more clearly understood from the following detailed description taken in conjunction with the accompanying drawings.

FIG. 1 is a flow chart illustrating a method of booting a information handling system according to an embodiment of the inventive concept.

FIG. 2 is a block diagram illustrating an example of a information handling system according to an embodiment of the inventive concept.

FIG. 3 is a flow chart illustrating a method of booting a information handling system according to an embodiment of the inventive concept.

FIG. 4 is a block diagram illustrating an example of a information handling system performing a boot method of FIG. 3.

FIG. 5 is a block diagram illustrating another example of a information handling system performing a boot method of FIG. 3.

FIG. 6 is a flow chart illustrating a method of booting a information handling system according to an embodiment of the inventive concept.

FIG. 7 is a block diagram illustrating an example of a information handling system performing a boot method of FIG. 6.

FIG. 8 is a block diagram illustrating another example of a information handling system performing a boot method of FIG. 6.

FIG. 9 is a flow chart illustrating a method of booting a information handling system according to an embodiment of the inventive concept.

FIG. 10 is a block diagram illustrating an example of a information handling system performing a boot method of FIG. 9.

FIG. 11 is a block diagram illustrating another example of a information handling system performing a boot method of FIG. 9.

FIG. 12 is a flow chart illustrating a method of booting a information handling system according to an embodiment of the inventive concept.

FIG. 13 is a block diagram illustrating an example of a information handling system performing a boot method of FIG. 12.

FIG. 14 is a block diagram illustrating another example of a information handling system performing a boot method of FIG. 12.

FIGS. 15A through 15F are diagrams illustrating examples of a memory module according to an embodiment of the inventive concept.

FIGS. 16A through 16D are diagrams illustrating examples of a memory interface according to an embodiment of the inventive concept.

FIG. 17 is a block diagram illustrating a mobile system according to an embodiment of the inventive concept.

FIG. 18 is a block diagram illustrating a server system according to an embodiment of the inventive concept.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

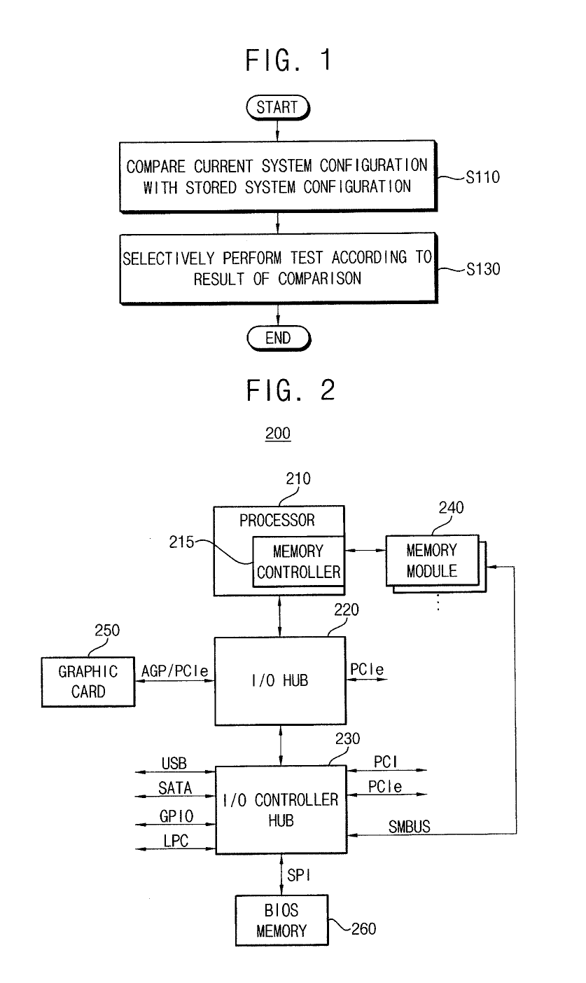

FIG. 1 is a flow chart illustrating a method of booting a information handling system according to an embodiment of the inventive concept.

Referring to FIG. 1, when a information handling system is booted, a current system configuration is compared with a stored system configuration (S110). For example, in a case where the information handling system is powered on, in a case where the information handling system is reset, or in a case where a power state of the information handling system transitions, the current system configuration may be compared with the stored system configuration.

Here, the stored system configuration is a configuration that has been stored in a nonvolatile memory device included in the information handling system when the information handling system was previously booted. Further, the current system configuration is a configuration when the information handling system is currently booted. For example, the information handling system may include a processor, a board, at least one device and the nonvolatile memory device, and the current system configuration of the processor, the board and the at least one device may be compared with the stored system configuration of the processor, the board and the at least one device. In this case, to compare the current system configuration with the stored system configuration, stored identification information of the processor, the board and the at least one device is read as the stored system configuration, current identification information of the processor, the board and the at least one device is obtained as the current system configuration, and the current identification information may be compared with the stored identification information. In some embodiments, identification information of each device may include a type of the device, a revision of the device, a serial number of the device, etc.

The nonvolatile memory device may retain the stored identification information of the processor, the board and the at least one device even if power is not supplied to the nonvolatile memory device. The nonvolatile memory device may be any nonvolatile memory device included in the information handling system. In some embodiments, the nonvolatile memory device may be included in the at least one device. In other embodiments, the nonvolatile memory device may be a basic input output system (BIOS) memory device that stores a boot code for the information handling system. For example, the nonvolatile memory device may include an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc.

The at least one device is selectively tested according to a result of the comparison of the current system configuration and the stored system configuration (S130). For example, the at least one device may be tested if the current system configuration is different from the stored system configuration, and the at least one device may not be tested if the current system configuration is the same as the stored system configuration.

Here, the test for the at least one device may include a built-in self-test (BIST) of the at least one device, and/or training for the at least one device. Further, the at least one device may include any device on which the test is typically performed during booting the information handling system. In some embodiments, the at least one device may be a volatile memory device such as a dynamic random access memory (DRAM). More specifically, the DRAM includes a mobile DRAM using for a mobile information handling system such as notebooks and smart phones. Alternatively, the at least one device is a memory module of a plurality of DRAMs, a graphic card, or the processor. For example, if the current system configuration is the same as the stored system configuration, or if a system configuration during a current booting operation has not been changed compared with a system configuration during a previous booting operation, the BIST and/or the training for the memory device, the memory module, the graphic card or the processor may not be performed.

If the current system configuration is different fromes the stored system configuration, the test for the at least one device may be performed. For example, in a case where the information handling system is booted for the first time, or in a case where the processor, the board or the at least one device is replaced, the test may be performed. After the test, a result of the test may be stored in the nonvolatile memory device, and the current system configuration may be stored as the stored system configuration in the nonvolatile memory device. The current system configuration stored in the nonvolatile memory device may be used as the stored system configuration during subsequent booting operations.

If the current system configuration is the same as the stored system configuration, the test may not be performed, the result of the test stored during a previous booting operation may be read from the nonvolatile memory device, and the read result of the test may be applied to the at least one device or the information handling system.

As described above, in a method of booting a information handling system according to example embodiments, the test for the at least one device, such as the BIST, the training, etc., may be selectively performed according to whether a system configuration is changed, thereby reducing a boot time and power consumption.

FIG. 2 is a block diagram illustrating an example of a information handling system according to an embodiment of the inventive concept.

Referring to FIG. 2, a information handling system 200 includes a processor 210, an input/output hub 220, an input/output controller hub 230, at least one memory module 240, a graphic card 250 and a BIOS memory device 260. In some embodiments, the information handling system 200 may be any information handling system, such as a personal computer (PC), a server computer, a workstation, a tablet computer, a laptop computer, a mobile phone, a smart phone, a personal digital assistant (PDA), a portable multimedia player (PMP), a digital camera, a digital television, a set-top box, a music player, a portable game console, a navigation device, etc.

The processor 210 may be mounted on a board (not shown), such as a motherboard, a main board, or the like. The processor 210 may perform specific calculations or tasks. For example, the processor 210 may be a microprocessor, a central process unit (CPU), a digital signal processor, or the like. The processor 210 may include any number of processor cores. For example, the processor 210 may be a single core processor or a multi-core processor, such as a dual-core processor, a quad-core processor, a hexa-core processor, etc. In an alternative embodiment, the information handling system 200 may include a plurality of processors. The processor 210 may be coupled to a cache memory inside or outside the processor 210.

The processor 210 may include a memory controller 215 that controls an operation of the memory module 240. The memory controller 215 included in the processor 210 may be referred to as an integrated memory controller (IMC). In an alternative embodiment, the memory controller 215 may be included in the input/output hub 220. The input/output hub 220 including the memory controller may be referred to as a memory controller hub (MCH).

The input/output hub 220 may be mounted on the board, and may manage data transfer between the processor 210 and devices, such as the graphic card 250. The input/output hub 220 may be coupled to the processor 210 via one of various interfaces including a front side bus (FSB), a system bus, a HyperTransport, a lightning data transport (LDT), a QuickPath interconnect (QPI), and a common system interface (CSI). In an alternative embodiment, the information handling system 200 may include a plurality of input/output hubs.

The input/output hub 220 may provide various interfaces with the devices including an accelerated graphics port (AGP) interface, a peripheral component interface-express (PCIe), and a communications streaming architecture (CSA) interface.

The graphic card 250 may be coupled to the input/output hub 220 via the AGP or the PCIe. The graphic card 250 may control a display device for displaying an image. The graphic card 250 may include an internal processor and an internal memory to process the image. In some embodiments, when the information handling system 200 is booted, a BIST of the graphic card 250 or training between the internal processor and the internal memory may be selectively performed. In an alternative embodiment, an internal graphic device may be integrated into the input/output hub 220. The internal graphic device may be referred to as an integrated graphics, and an input/output hub including the memory controller and the internal graphic device may be referred to as a graphics and memory controller hub (GMCH).

The input/output controller hub 230 may be mounted on the board, and may perform data buffering and interface arbitration to efficiently operate various system interfaces. The input/output controller hub 230 may be coupled to the input/output hub 220 via various interfaces including a direct media interface (DMI), a hub interface, an enterprise Southbridge interface (ESI), and PCIe.

The input/output controller hub 230 may provide various interfaces with peripheral devices. For example, the input/output controller hub 230 may provide a universal serial bus (USB) port, a serial advanced technology attachment (SATA) port, a general purpose input/output (GPIO), a low pin count (LPC) bus, a PCI, and a PCIe. Further, the input/output controller hub 230 may control an interface with the BIOS memory device 260. For example, the interface may include a serial peripheral interface (SPI), and an interface with the memory module 240, such as an I2C serial bus, or a system management bus (SMBUS).

The BIOS memory device 260 may store a BIOS code for booting the information handling system 200. The BIOS code may include a power on self test (POST) code that detects hardwares, such as a keyboard, the memory module 240, and a disk drive, and checks whether these hardwares operate normally. The BIOS code may further include, as part of the POST code, a memory reference code (MRC) for initializing the memory module 240. The MRC may include various algorithms for configuring the memory controller 215 to normally interoperate with the memory module 240. For example, by the MRC executed by the processor 210, serial presence detect (SPD) data may be read from a SPD memory device included in the memory module 240 via the SMBUS, and parameters of the memory controller 215, such as a frequency, operation timing, etc., may be set based on the SPD data. Further, a BIST and/or training for the memory module 240 may be performed by the MRC.

The memory module 240 may be coupled to the memory controller 215 via a memory interface, and may be coupled to the input/output controller hub 230 via the SMBUS. For example, data, addresses and commands may be transferred between the memory module 240 and the memory controller 215 via the memory interface, and the SPD data may be transferred between the memory module 240 and the input/output controller hub 230 via the SMBUS. The SPD data may include information about a type and/or timing of the memory module 240. For example, the SPD data may include a type of memory devices included in the memory module 240, a type of the memory module 240, operation timing information, manufacturing information, a revision code, a serial number, etc.

The memory interface between the memory module 240 and the memory controller 215 may be implemented by at least one channel including a plurality of signal lines. Each channel may be coupled to at least one memory module 240. By executing the MRC code, the training for the memory module 240 may optimize signal integrity for chip-to-chip connections between the memory module 240 and the memory controller 215.

In some embodiments, the processor 210, the input/output hub 220 and the input/output controller hub 230 may be implemented as separate chipsets or separate integrated circuits. In other embodiments, at least two of the processor 210, the input/output hub 220 and the input/output controller hub 230 may be integrated as one chipset. A chipset including the input/output hub 220 and the input/output controller hub 230 may be referred to as a controller chipset, and a chipset including the processor 210, the input/output hub 220 and the input/output controller hub 230 may be referred to as a processor chipset.

Hereinafter, an exemplary method of booting the information handling system 200 will be described below with reference to FIG. 2.

In a case where the information handling system 200 is powered on, in a case where the information handling system 200 is reset, or in a case where a power state of the information handling system 200 transitions, the information handling system 200 may be booted. During a booting operation, the BIOS code stored in the BIOS memory device 260 may be read via the SPI, and the read BIOS code may be executed by the processor 210.

The BIOS code may include a first instruction to read a stored system configuration from a nonvolatile memory device included in the information handling system 200. The nonvolatile memory device storing the system configuration may be the SPD memory device included in the memory module 240. In an alternative embodiment, the nonvolatile memory device storing the system configuration may be the BIOS memory device 260.

In operation, when the processor 210 executes the first instruction of the BIOS code, the processor 210 get a system configuration of a previous booting procedure stored in the nonvolatile memory device. The system configuration stored in the previous booting procedure includes identification information of the processor 210, the board and at least one device that are used in the previous booting procedure. In some embodiments, the at least one device may include the processor 210, the graphic card 250, the memory module 240 or another memory device. For example, the identification information of the processor 210, the board and the at least one device may include serial numbers of the processor 210, the board and the at least one device.

The BIOS code may further include a second instruction to obtain a current system configuration from the information handling system 200. In some embodiments, by executing the second instruction of the BIOS code, current identification information of the processor 210, the board and the at least one device may be obtained as the current system configuration. In some embodiments, the MRC may include the second instruction for obtaining the current identification information.

In operation, when the processor 210 executes the second instruction, the processor 210 gets current identification information from the processor 210, board, and the at least one device as a current system configuration. For example, the processor 210 extracts a current serial number of the processor 210 as a current identification information of the processor 210. Further, the processor 210 may extract, as a current serial number of the board (i.e., the current identification information of the board), the stored serial number of the board from the BIOS memory device 260 via the SPI. In addition, in a case where the at least one device is the memory module 240, the processor 210 may extract, as the current identification information of the at least one device, a current serial number of the memory module 240 from the SPD memory device included in the memory module 240 via the SMBUS.

If the current identification information is different from the stored identification information, the processor 210 may initialize the at least one device. Initializing the at least one device includes a step of training the at least one device and a step of performing a test (e.g., a BIST or training) for the at least one device. The step of training the at least one device may include optimization of signal integrity on channels between the at least one device and the processor 210. The step of performing a test for the at least one device may include a functionality test. For example, when the at least one device include a memory device, the functionality test is to check whether memory cells work as specified in a specification. Specifically, if current serial numbers of the processor 210, the board and the at least one device that are extracted during a current booting operation are different from stored serial numbers of the processor 210, the board and the at least one device that are stored in the nonvolatile memory device, the BIST and/or the training for the at least one device may be performed.

When the processor 210 completes to initialize the at least one device, a result of the BIST and/or a result of the training may be stored in the nonvolatile memory device, and the current identification information (e.g., the current serial numbers of the processor, the board and the at least one device that are extracted during the current booting operation) may be stored in the nonvolatile memory device. The current identification information stored in the nonvolatile memory device may be used as the stored identification information during subsequent booting operations.

If the current identification information is the same as the stored identification information, the processor 210 may not initialize the at least one device and apply a trained result stored in the nonvolatile memory device in a previous booting procedure to the at least one device or the information handling system 200. For example, if the current serial numbers are the same as the stored serial numbers, the BIST and/or the training for the at least one device may not be performed, and the result of the BIST and/or the result of the training stored in the nonvolatile memory device may be applied. For example, the BIST and the training for the memory module 240 may not be performed, and operation parameters of the memory controller 215 and/or the memory module 240 may be set using the result of the BIST and the result of the training that are stored in the nonvolatile memory device (i.e., the results of the BIST and the training performed during a previous booting operation).

As described above, when the information handling system 200 according to example embodiments is booted, the test for the at least one device may be selectively performed according to whether a system configuration is changed, thereby reducing a boot time and power consumption.

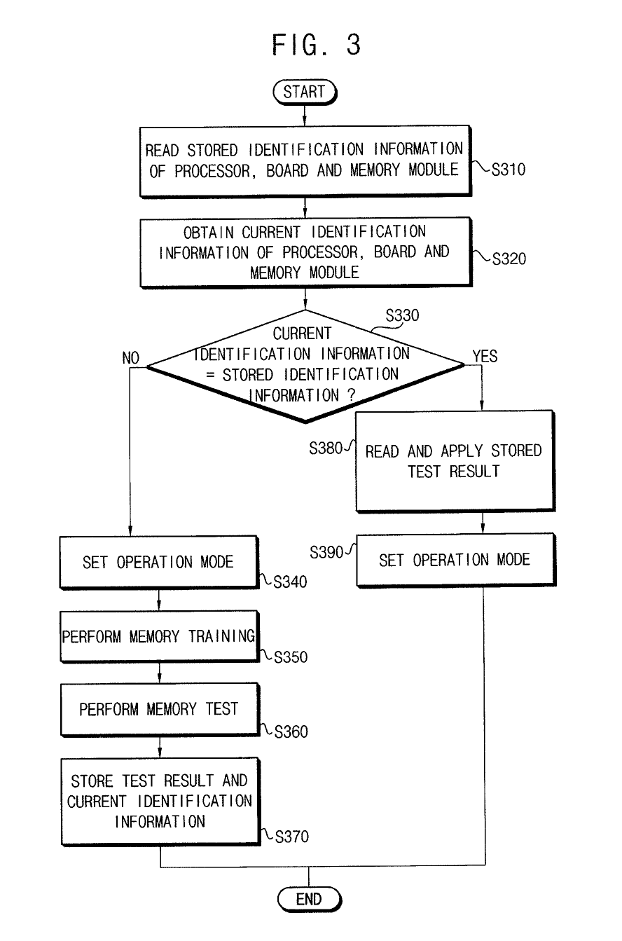

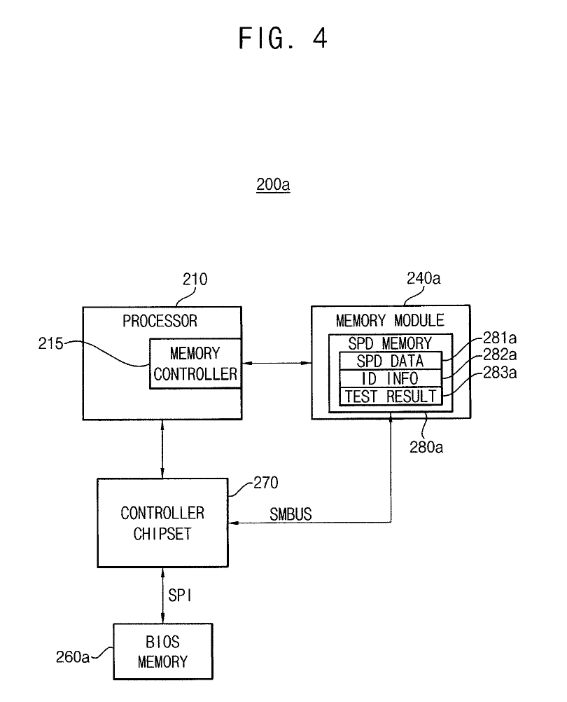

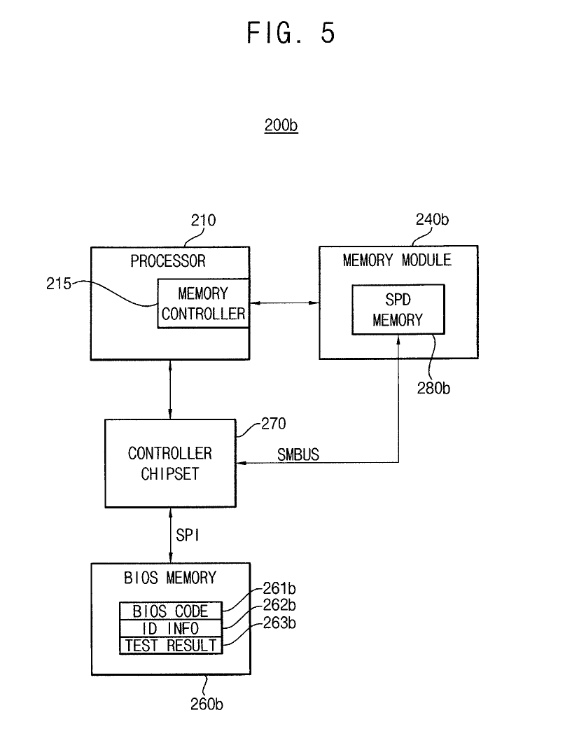

FIG. 3 is a flow chart illustrating a method of booting a information handling system according to example embodiments, FIG. 4 is a block diagram illustrating an example of a information handling system performing a boot method of FIG. 3, and FIG. 5 is a block diagram illustrating another example of a information handling system performing a boot method of FIG. 3.

Referring to FIGS. 3, 4 and 5, when a information handling system 200a or 200b is booted, stored identification information 282a or 262b of a processor 210, a board (not shown) and a memory module 240a or 240b is read (S310). In FIG. 4, the stored identification information 282a may be read from an SPD memory device 280a included in the memory module 240a via a system management bus SMBUS. In FIG. 5, the stored identification information 262b may be read from a BIOS memory device 260b via a serial peripheral interface SPI. For example, the stored identification information 282a or 262b may include stored serial numbers of the processor 210, the board and the memory module 240a or 240b. In an alternative embodiment, the stored identification information 282a or 262b may be stored in a nonvolatile memory device other than the SPD memory device 280a or 280b and the BIOS memory device 260a or 260b.

During a booting operation of the information handling system 200a or 200b, current identification information of the processor 210, the board and the memory module 240a or 240b is obtained (S320). A BIOS code 261b stored in the BIOS memory device 260a or 260b may include an instruction to read the current identification information, and the processor 210 may obtain the current identification information by executing the BIOS code 261b. For example, the processor 210 may extract a current serial number of the processor 210 by executing a specific instruction, may extract a current serial number of the board by accessing the BIOS memory device 260a or 260b via a controller chipset 270 and the serial peripheral interface SPI, and may extract a current serial number of the memory module 240a or 240b by accessing the SPD memory device 280a or 280b via the controller chipset 270 and the system management bus SMBUS.

If a current system configuration during a current booting operation is different from a stored system configuration before the current booting operation, or if the current identification information is different from the stored identification information 282a or 262b (S330: NO), a memory controller 215 may set a operation mode of the memory module 240a or 240b (S340), and the memory controller 215 may perform memory training and a memory test for the memory module 240a or 240b (S350 and S360). For example, in a case where the information handling system 200a or 200b is initially booted, or in a case where at least one of the processor 210, the board and the memory module 240a or 240b is replaced, the memory training and the memory test may be performed.

For example, the memory controller 215 may set the operation mode of the memory module 240a or 240b, such as a burst length, a burst type, a column address strobe (CAS) latency, a test mode, a delay locked loop (DLL) reset, etc (S340). The setting of the operation mode may be referred to as a mode register setting. Further, the memory controller 215 may perform the memory training to calibrate an interface with the memory module 240a or 240b (S350). For example, the memory controller 215 may perform write/read leveling, address training, clock training, write/read re-center training, etc. In addition, the memory controller 215 may control the memory module 240a or 240b to perform a BIST as the memory test (S360). For example, the memory module 240a or 240b may be controlled to perform a memory full cell test to verify whether entire memory cells normally operate.

After the memory training and the memory test, the processor 210 may store a test result 283a or 263b of the memory training and the memory test in a nonvolatile memory device included in the information handling system 200a or 200b, and may store the current identification information as the stored identification information 282a or 262b in the nonvolatile memory device (S370). In some embodiments, the processor 210 may store the test result 283a and the identification information 282a in the SPD memory device 280a via the system management bus SMBUS. In other embodiments, the processor 210 may store the test result 263b and the identification information 262b in the BIOS memory device 260b via the serial peripheral interface SPI. Although FIG. 4 illustrates an example where the test result 283a and the identification information 282a are stored in the SPD memory device 280a, and FIG. 5 illustrates an example where the test result 263b and the identification information 262b are stored in the BIOS memory device 260b, in some embodiments, the test result 283a or 263b and the identification information 282a or 262b may be stored in the SPD memory device 280a or 280b and the BIOS memory device 260a or 260b, respectively. In other embodiments, the test result 283a or 263b and the identification information 282a or 262b may be stored in a nonvolatile memory device other than the SPD memory device 280a or 280b and the BIOS memory device 260a or 260b.

If the current system configuration during the current booting operation is the same as the stored system configuration before the current booting operation, or if the current identification information is the same as the stored identification information 282a or 262b (S330: YES), the memory training and the memory test may not be performed. In this case, the processor 210 may apply the test result 283a or 263b stored in the nonvolatile memory device to the memory controller 215 and the memory module 240a or 240b (S380). In some embodiments, the processor 210 may read the test result 283a from the SPD memory device 280a, and may apply the test result 283a to the memory controller 215 and the memory module 240a. In other embodiments, the processor 210 may read the test result 262b from the BIOS memory device 260a, and may apply the test result 262b to the memory controller 215 and the memory module 240b. Further, the memory controller 215 may set the operation mode of the memory module 240a or 240b (S390).

As described above, in a method of booting the information handling system 200a or 200b according to example embodiments, the memory training and the memory test may be selectively performed according to whether a system configuration is changed, thereby reducing a boot time and power consumption.

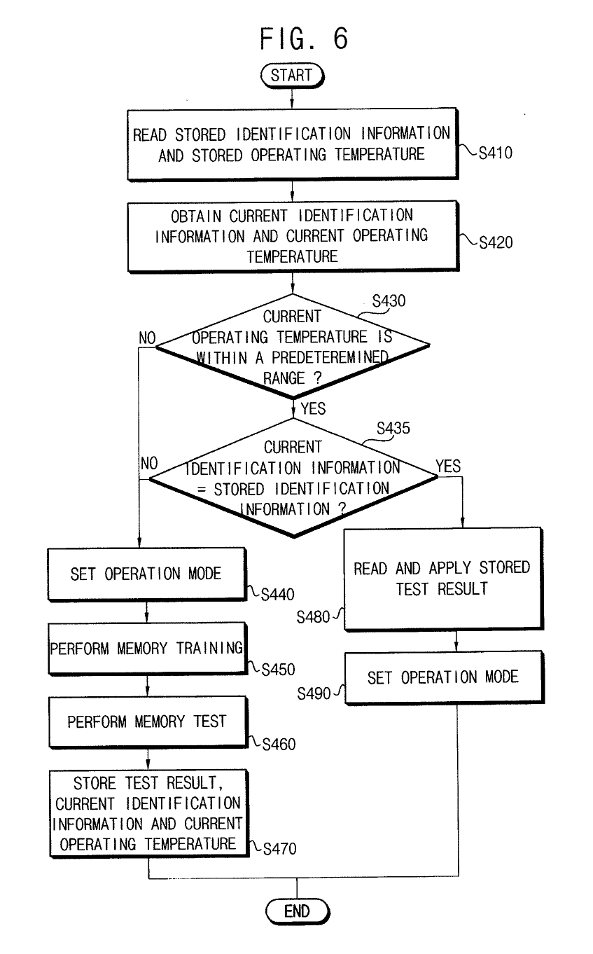

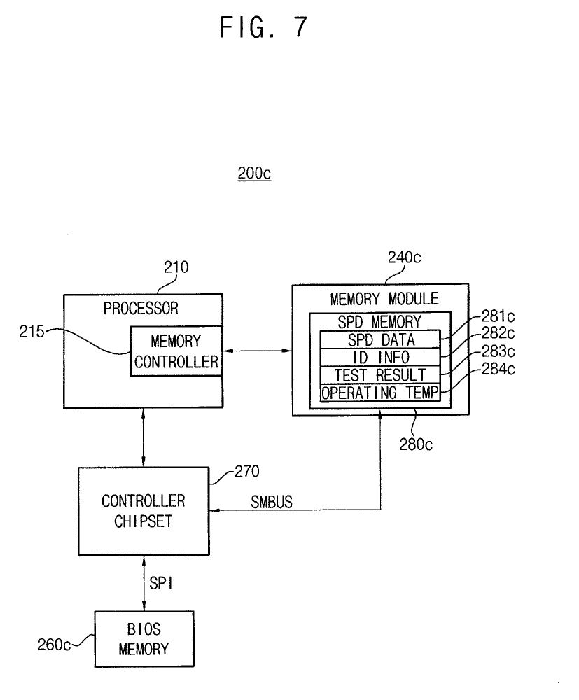

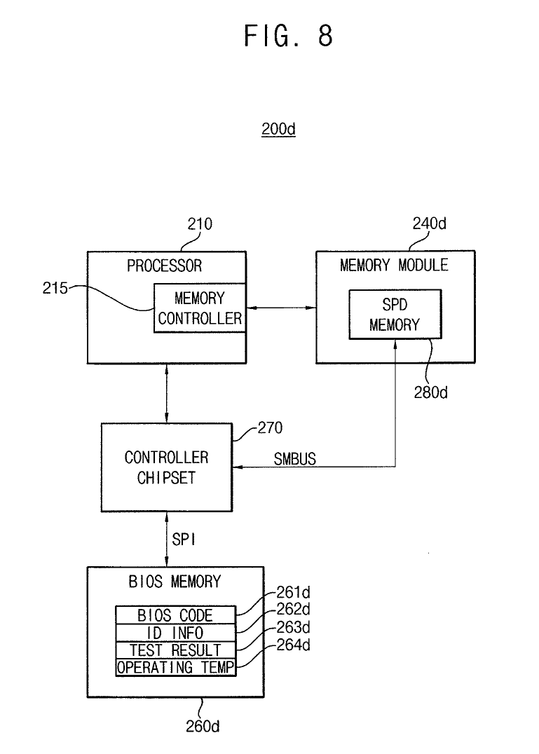

FIG. 6 is a flow chart illustrating a method of booting a information handling system according to example embodiments, FIG. 7 is a block diagram illustrating an example of a information handling system performing a boot method of FIG. 6, and FIG. 8 is a block diagram illustrating another example of a information handling system performing a boot method of FIG. 6.

Referring to FIGS. 6, 7 and 8, when a information handling system 200c or 200d is booted, stored identification information 282c or 262d of a processor 210, a board (not shown) and a memory module 240c or 240d and a stored operating temperature 284c or 264d are read (S410). In FIG. 7, the stored identification information 282c and the stored operating temperature 284c may be read from an SPD memory device 280c included in the memory module 240c via a system management bus SMBUS. In FIG. 8, the stored identification information 282d and the stored operating temperature 284d may be read from a BIOS memory device 260d via a serial peripheral interface SPI. For example, the stored identification information 282c or 262d and the stored operating temperature 284c or 264d may be stored and read from the same nonvolatile memory device (e.g., the SPD memory device 280c or the BIOS memory device 260d), from different nonvolatile memory device, or from a nonvolatile memory device other than the SPD memory device 280c or 280d and the BIOS memory device 260c or 260d.

During a booting operation of the information handling system 200c or 200d, current identification information of the processor 210, the board and the memory module 240c or 240d and current operating temperature are obtained (S420). The processor 210 may obtain the current identification information by executing a BIOS code 261d stored in the BIOS memory device 260c or 260d. Further, the processor 210 may control a temperature sensor (not shown) inside or outside the processor 210 to obtain the current operating temperature.

If the current operating temperature is out of a predetermined range (S430: NO) or if the current identification information is different from the stored identification information 282c or 262d although the current operating temperature is within the predetermined range (S430: YES and S435: NO), a memory controller 215 may set a operation mode of the memory module 240c or 240d (S440), and may perform memory training and a memory test for the memory module 240c or 240d (S450 and S460). The predetermined range may be determined based on the stored operating temperature. For example, the predetermined range may be a range from the stored operating temperature minus about 10° C. to the stored operating temperature plus about 10° C.

After the memory training and the memory test, the processor 210 may store a test result 283c or 263d of the memory training and the memory test in a nonvolatile memory device included in the information handling system 200c or 200d, may store the current identification information as the stored identification information 282c or 262d in the nonvolatile memory device, and may store the current operating temperature as the stored operating temperature 284c or 264d (S470). Accordingly, if the memory training and the memory test are performed, the current operating temperature during a current booting operation may be used as the stored operation temperature 284c or 264d during subsequent booting operations. The test result 283c or 263d, the identification information 282c or 262d and the operating temperature 284c or 264d may be stored in the same nonvolatile memory device (e.g., the SPD memory device 280c or the BIOS memory device 260d) or in different nonvolatile memory devices.

If the current operating temperature is within the predetermined range and the current identification information is the same as the stored identification information 282c or 262d (S430: YES and S435: YES), the memory training and the memory test may not be performed, and the processor 210 may apply the test result 283c or 263d stored in the SPD memory device 280c or the BIOS memory device 260d to the memory controller 215 and the memory module 240c or 240d (S480). Further, the memory controller 215 may set the operation mode of the memory module 240c or 240d (S490).

As described above, in a method of booting the information handling system 200c or 200d according to example embodiments, the memory training and the memory test may be selectively performed according to whether a system configuration is changed and whether an operating temperature is changed, thereby reducing a boot time and power consumption.

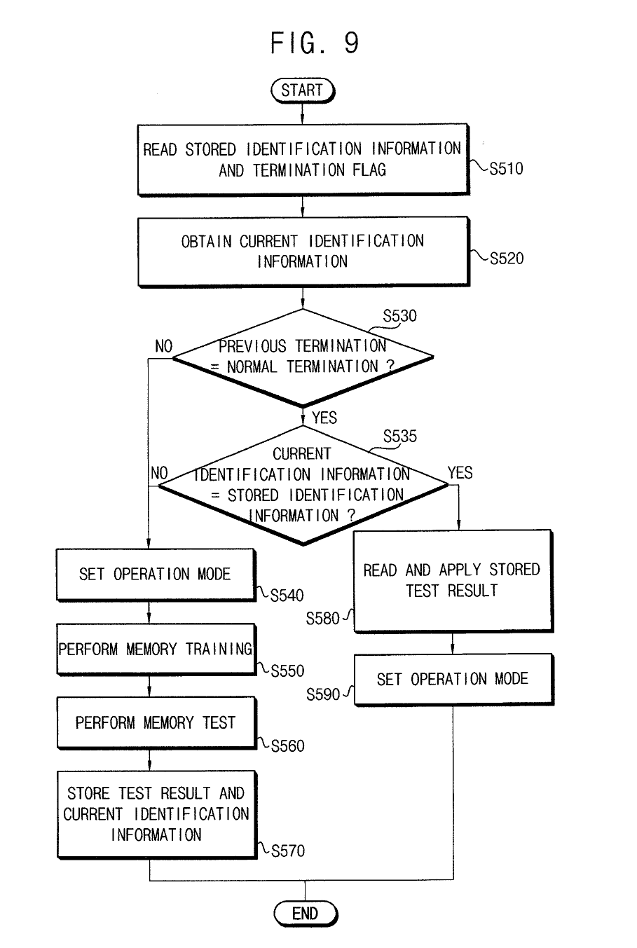

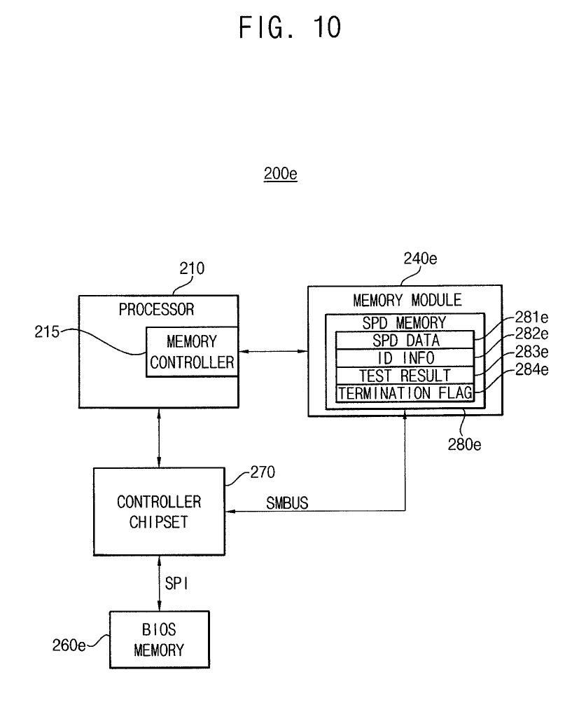

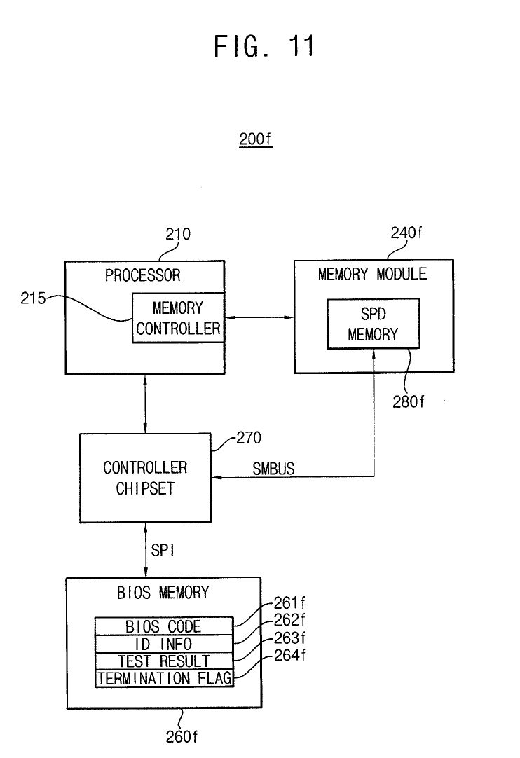

FIG. 9 is a flow chart illustrating a method of booting a information handling system according to example embodiments, FIG. 10 is a block diagram illustrating an example of a information handling system performing a boot method of FIG. 9, and FIG. 11 is a block diagram illustrating another example of a information handling system performing a boot method of FIG. 9.

Referring to FIGS. 9, 10 and 11, when a information handling system 200e or 200f is booted, stored identification information 282e or 262f of a processor 210, a board (not shown) and a memory module 240e or 240f and a termination flag 284e or 264f are read (S510). In some embodiments, the stored identification information 282e and the termination flag 284e may be read from an SPD memory device 280e included in the memory module 240e via a system management bus SMBUS. In other embodiments, the stored identification information 282f and the termination flag 284f may be read from a BIOS memory device 260f via a serial peripheral interface SPI. For example, the stored identification information 282e or 262f and the termination flag 284e or 264f may be stored and read from the same nonvolatile memory device (e.g., the SPD memory device 280e or the BIOS memory device 260f), from different nonvolatile memory device, or from a nonvolatile memory device other than the SPD memory device 280e or 280f and the BIOS memory device 260e or 260f.

The termination flag 284e or 264f may be written when the information handling system 200e or 200f is terminated, and may indicate whether the information handling system 200e or 200f is normally terminated. That is, the termination flag 284e or 264f may indicate whether a previous termination is a normal termination. For example, when the information handling system 200e or 200f is normally terminated, the processor 210 may write “1” into the termination flag 284e or 264f. Accordingly, when the information handling system 200e or 200f is later booted, the processor 210 may recognize that the previous termination is the normal termination based on the termination flag 284e or 264f of “1”. Further, the processor 210 may write “0” into the termination flag 284e or 264f after the information handling system 200e or 200f is normally booted. If the information handling system 200e or 200f is abnormally terminated, the processor 210 may not be able to update the termination flag 284e or 264f. In this case, the processor 210 may recognize that the previous termination is an abnormal termination based on the termination flag 284e or 264f of “0”.

During a booting operation of the information handling system 200e or 200f, current identification information of the processor 210, the board and the memory module 240e or 240f is obtained (S520). The processor 210 may obtain the current identification information by executing a BIOS code 261f stored in the BIOS memory device 260e or 260f.

If the previous termination is the abnormal termination (S530: NO) or if the current identification information is different from the stored identification information 282e or 262f although the previous termination is the normal termination (S530: YES and S535: NO), a memory controller 215 may set a operation mode of the memory module 240e or 240f (S440), and may perform memory training and a memory test for the memory module 240e or 240f (S550 and S560). For example, if the termination flag 284e or 264f is “1”, the processor 210 may determine that the previous termination is the normal termination.

After the memory training and the memory test, the processor 210 may store a test result 283e or 263f of the memory training and the memory test in a nonvolatile memory device included in the information handling system 200e or 200f, and may store the current identification information as the stored identification information 282e or 262f in the nonvolatile memory device (S570). The test result 283e or 263f and the identification information 282e or 262f may be stored in the same nonvolatile memory device (e.g., the SPD memory device 280e or the BIOS memory device 2600 or in different nonvolatile memory devices.

If the previous termination is the normal termination and the current identification information is the same as the stored identification information 282e or 262f (S530: YES and S535: YES), the memory training and the memory test may not be performed, and the processor 210 may apply the test result 283e or 263f stored in the SPD memory device 280e or the BIOS memory device 260f to the memory controller 215 and the memory module 240e or 240f (S580). Further, the memory controller 215 may set the operation mode of the memory module 240e or 240f (S590).

As described above, in a method of booting the information handling system 200e or 200f according to example embodiments, the memory training and the memory test may be selectively performed according to whether a system configuration is changed and whether a previous termination is a normal termination, thereby reducing a boot time and power consumption.

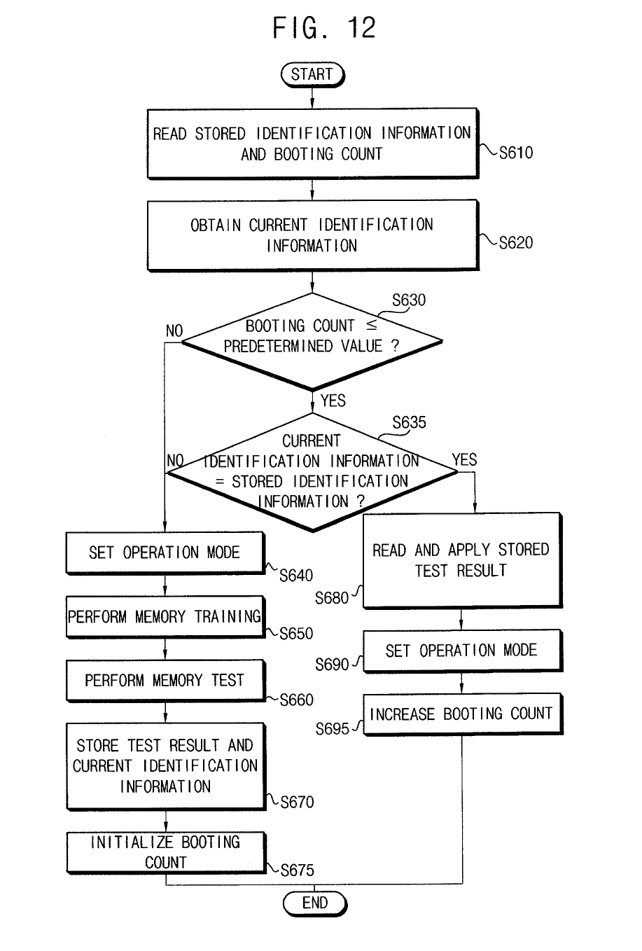

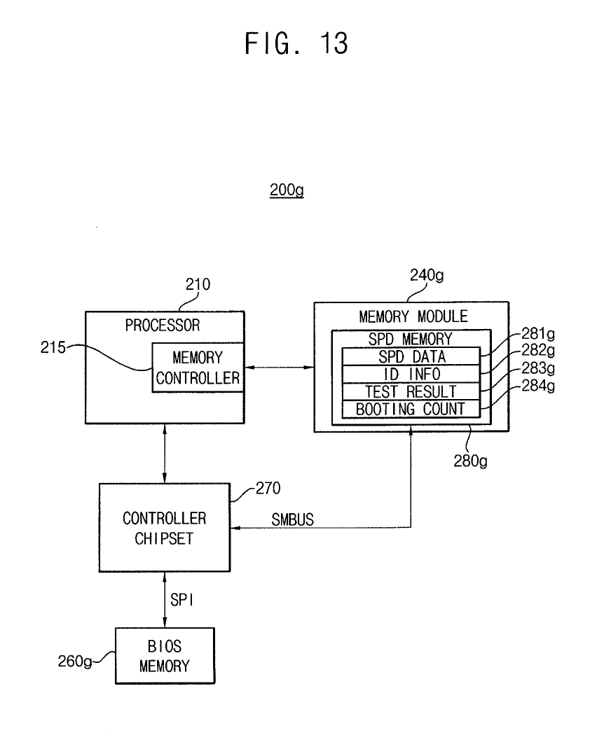

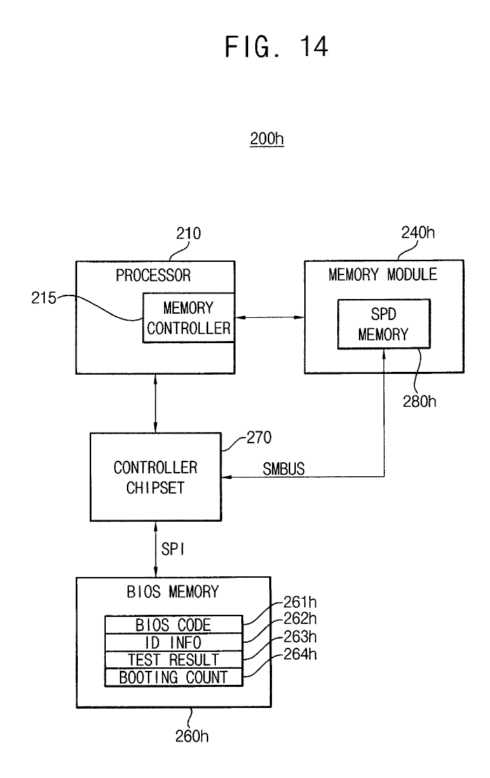

FIG. 12 is a flow chart illustrating a method of booting a information handling system according to example embodiments, FIG. 13 is a block diagram illustrating an example of a information handling system performing a boot method of FIG. 12, and FIG. 14 is a block diagram illustrating another example of a information handling system performing a boot method of FIG. 12.

Referring to FIGS. 12, 13 and 14, when a information handling system 200g or 200h is booted, stored identification information 282g or 262h of a processor 210, a board (not shown) and a memory module 240g or 240h and a booting count 284g or 264h are read (S610). In some embodiments, the stored identification information 282g and the booting count 284g may be read from an SPD memory device 280g included in the memory module 240g via a system management bus SMBUS. In other embodiments, the stored identification information 282h and the booting count 284h may be read from a BIOS memory device 260h via a serial peripheral interface SPI. For example, the stored identification information 282g or 262h and the booting count 284g or 264h may be stored and read from the same nonvolatile memory device (e.g., the SPD memory device 280g or the BIOS memory device 260h), from different nonvolatile memory device, or from a nonvolatile memory device other than the SPD memory device 280g or 280h and the BIOS memory device 260g or 260h.

The booting count 284g or 264h may indicate the number of booting operations that are consecutively performed without memory training and a memory test. For example, the booting count 284g or 264h may be initialized to 0 if the memory training and the memory test are performed, and may be increased by 1 if the information handling system 284g or 264h is booted without performing the memory training and the memory test.

During a booting operation of the information handling system 200g or 200h, current identification information of the processor 210, the board and the memory module 240g or 240h is obtained (S620). The processor 210 may obtain the current identification information by executing a BIOS code 261h stored in the BIOS memory device 260g or 260h.

If the booting count 284g or 264h is greater than a predetermined value (S630: NO) or if the current identification information is different from the stored identification information 282g or 262h although the booting count 284g or 264h is equal to or less than the predetermined value (S630: YES and S635: NO), a memory controller 215 may set a operation mode of the memory module 240g or 240h (S640), and may perform the memory training and the memory test for the memory module 240g or 240h (S650 and S660). For example, the predetermined value may be 10, and, if the information handling system 200g or 200h is consecutively booted ten times without performing the memory training and the memory test, the memory training and the memory test may be performed during the next booting operation.

After the memory training and the memory test, the processor 210 may store a test result 283g or 263h of the memory training and the memory test in a nonvolatile memory device included in the information handling system 200g or 200h, and may store the current identification information as the stored identification information 282g or 262h in the nonvolatile memory device (S670). The test result 283g or 263h and the identification information 282g or 262h may be stored in the same nonvolatile memory device (e.g., the SPD memory device 280g or the BIOS memory device 260h) or in different nonvolatile memory devices. Further, once the memory training and the memory test are performed, the processor 210 may initialize the booting count 284g or 264h to 0 (S675).

If the booting count 284g or 264h is equal to or less than the predetermined value and the current identification information is the same as the stored identification information 282g or 262h (S630: YES and S635: YES), the memory training and the memory test may not be performed, and the processor 210 may apply the test result 283g or 263h stored in the SPD memory device 280g or the BIOS memory device 260h to the memory controller 215 and the memory module 240g or 240h (S680). The memory controller 215 may set the operation mode of the memory module 240g or 240h (S690). Further, if the memory training and the memory test are not performed, the processor 210 may increase the booting count 284g or 264h by 1 (S695).

As described above, in a method of booting the information handling system 200g or 200h according to example embodiments, the memory training and the memory test may be selectively performed according to whether a system configuration is changed and the number of booting operations performed without the test, thereby reducing a boot time and power consumption.

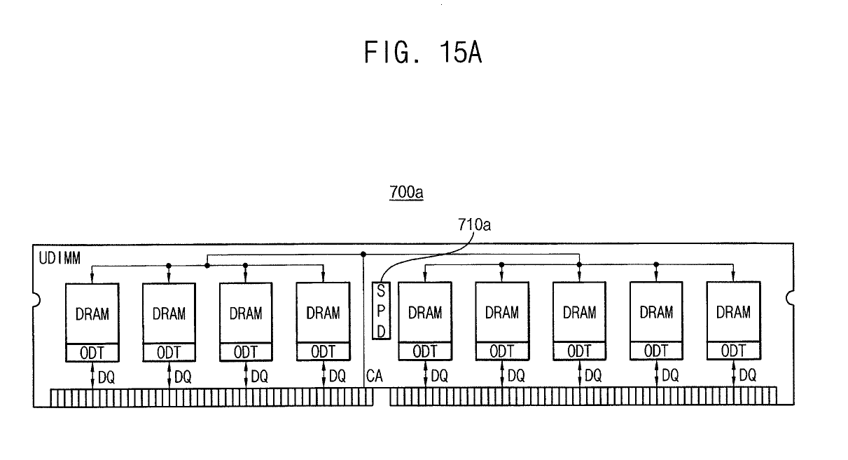

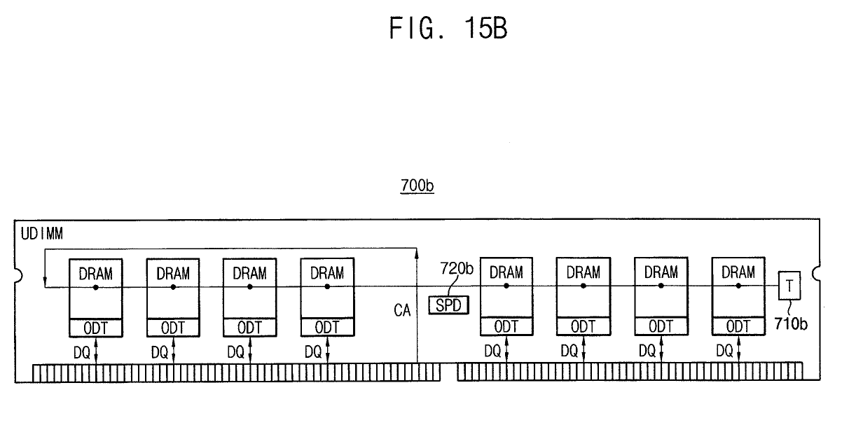

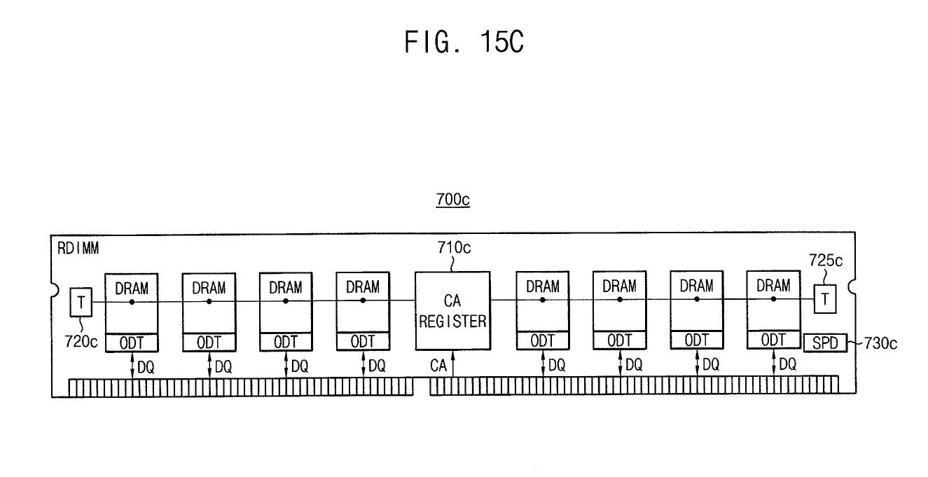

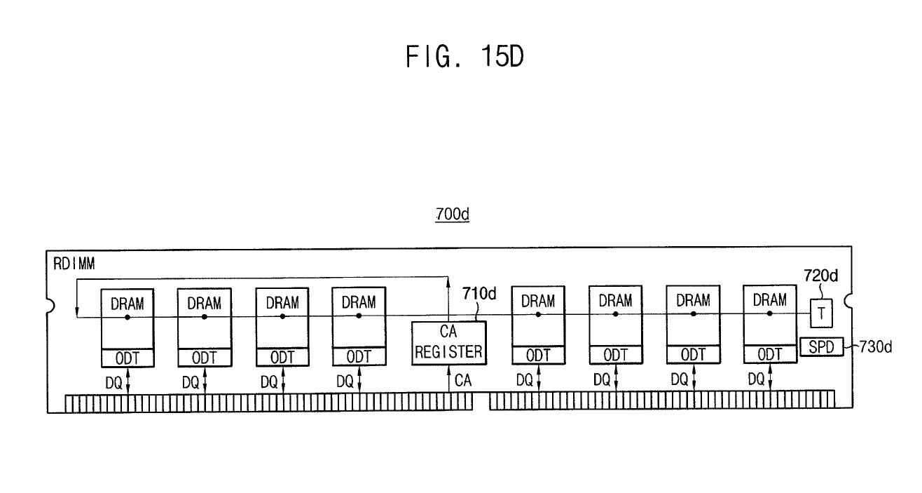

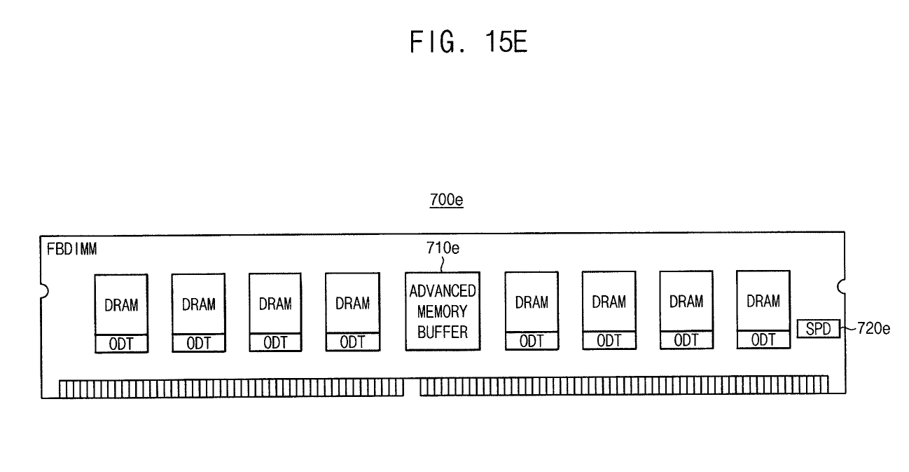

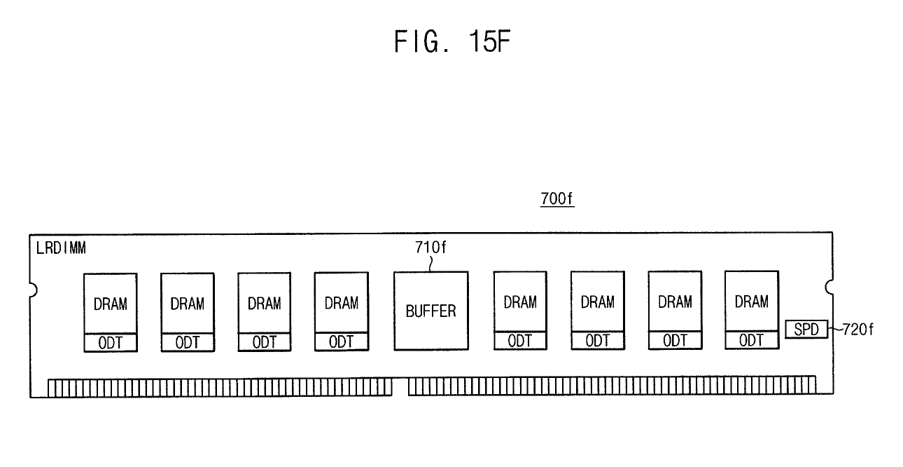

FIGS. 15A through 15F are diagrams illustrating examples of a memory module according to an embodiment of the inventive concept.

Referring to FIG. 15A, a memory module 700a may be implemented as an unbuffered dual in-line memory module (UDIMM). The memory module 700a may include a plurality of memory devices DRAM and an SPD memory device 710a that stores SPD data. The memory devices DRAM may be coupled to the data transmission lines DQ, and may provide on-die termination (ODT) to the data transmission lines DQ. The memory devices DRAM may be further coupled to command/address transmission lines CA in a tree topology. The SPD memory device 710a may be coupled to an external chipset via a system management bus. In some embodiments, a pseudo-differential signaling using a reference data voltage and a reference command/address voltage may be employed for transferring data and a command/address.

Referring to FIG. 15B, a memory module 700b may be implemented as an UDIMM. The memory module 700b may include a plurality of memory devices DRAM, a module termination resistor unit 710b and an SPD memory device 720b that stores SPD data. The module termination resistor unit 710b may be coupled to one end of command/address transmission lines CA. The command/address transmission lines CA may be coupled to the memory devices DRAM in a fly-by daisy-chain topology. The SPD memory device 720b may be coupled to an external chipset via a system management bus. The memory module 700b may perform read/write leveling.

Referring to FIG. 15C, a memory module 700c may be implemented as a registered dual in-line memory module (RDIMM). The memory module 700c may include a plurality of memory devices DRAM, a command/address register 710c, module resistor units 720c and 725c and an SPD memory device 730c that stores SPD data. The command/address register 710c may provide a command/address signal to the memory devices DRAM through command/address transmission lines CA, and the module resistor units 720c and 725c may be coupled to both ends of the command/address transmission lines CA. The command/address register 710c may be coupled to the memory devices DRAM in a daisy-chain topology. The SPD memory device 730c may be coupled to an external chipset via a system management bus.

Referring to FIG. 15D, a memory module 700d may be implemented as an RDIMM. The memory module 700d may include a plurality of memory devices DRAM, a command/address register 710d, a module resistor unit 720d and an SPD memory device 730d that stores SPD data. The command/address register 710d may provide a command/address signal to the memory devices through command/address transmission lines CA, and the module resistor unit 720d may be coupled to one end of the command/address transmission lines CA. The command/address register 710d may be coupled to the memory devices DRAM in a fly-by daisy-chain topology. The SPD memory device 730d may be coupled to an external chipset via a system management bus. The memory module 700d may perform read/write leveling.

Referring to FIG. 15E, a memory module 700e may be implemented as a fully buffered dual in-line memory module (FBDIMM). The memory module 700e may include a plurality of memory devices DRAM, a hub 710e and an SPD memory device 720e that stores SPD data. The hub 710e may provide a command/address signal and data by converting a high-speed packet received from a memory controller. For example, the hub 710e may be an advanced memory buffer AMB. The SPD memory device 720e may be coupled to an external chipset via a system management bus.

Referring to FIG. 15F, a memory module 700f may be implemented as a load reduced dual in-line memory module LRDIMM. The memory module 700f may include a plurality of memory devices DRAM, a buffer 710f and an SPD memory device 720f that stores SPD data. The buffer 710f may provide a command/address signal and data by buffering the command/address signal and the data from a memory controller through a plurality of transmission lines. The SPD memory device 720f may be coupled to an external chipset via a system management bus.

Data transmission lines between the buffer 710f and the memory devices DRAM may be coupled in a point-to-point topology. Command/address transmission lines between the buffer 710f and the memory devices DRAM may be coupled in a multi-drop topology, a daisy-chain topology, a fly-by daisy-chain topology, or the like. Since the buffer 710f buffers both the command/address signal and the data, the memory controller may interface with the memory module 700f by driving only a load of the buffer 710f. Accordingly, the memory module 700f may include more memory devices DRAM and more memory ranks, and a memory system may include more memory modules.

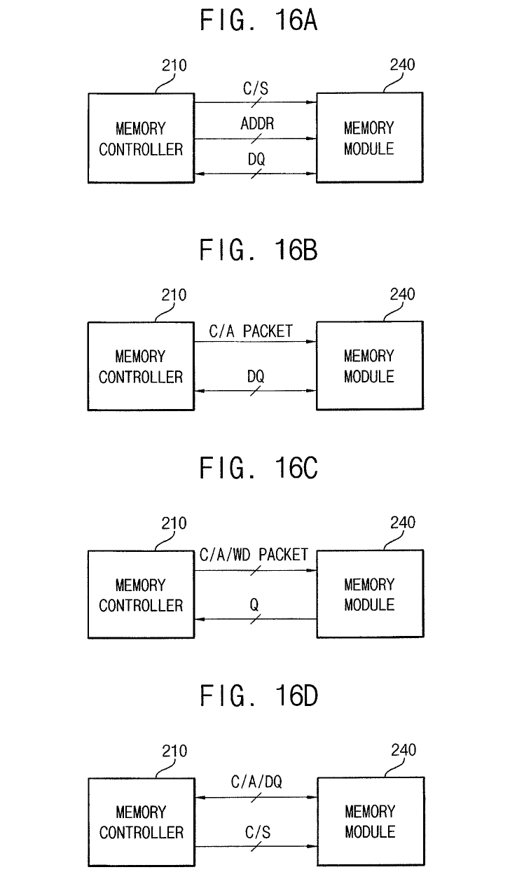

FIGS. 16A through 16D are diagrams illustrating examples of a memory interface according to an embodiment of the inventive concept.

FIG. 16A illustrates an interface between a memory controller 210 and a memory module 240. Referring to FIG. 16A, the memory controller 210 may transmit a control signal C/S and an address signal ADDR to the memory module 240 through a control signal line and an address signal lines, respectively. For example, the control signal C/S may include a CLE signal, an ALE signal, a /CE signal, a /RE signal, a /WE signal, a /WP signal, a R/B signal, etc. Data DQ may be transferred in both directions from the memory controller 210 to the memory module 240 and from the memory module 240 to the memory controller 210.

Referring to FIG. 16B, a memory controller 210 may transmit packetized control signals and address signals C/A PACKET to a memory module 240. Data DQ may be transferred in both directions.

Referring to FIG. 16C, a memory controller 210 may transmit packetized control signals, address signals and write signals C/A/WD PACKET to a memory module 240. Output data Q may be transferred in one direction from the memory module 240 to the memory controller 210.

Referring to FIG. 16D, a memory controller 210 may transmit control signals C/S to a memory module 240. Command, address and data C/A/DQ may be transferred in both directions.

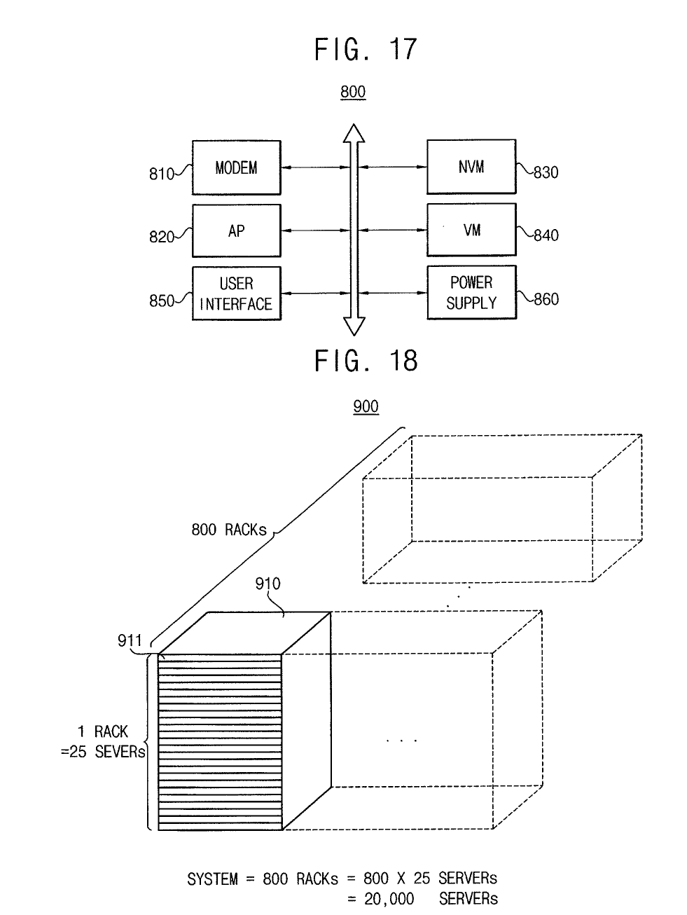

FIG. 17 is a block diagram illustrating a mobile system according to an embodiment of the inventive concept.

Referring to FIG. 17, a mobile system 800 includes a modem 810 (e.g., baseband chipset), an application processor 820, a nonvolatile memory device 830, a volatile memory device 840, a user interface 850, and a power supply 860. For example, the mobile system 800 may be a mobile phone, a smart phone, a personal digital assistant (PDA), a portable multimedia player (PMP), a digital camera, a portable game console, a music player, a camcorder, a video player, etc.

The modem 810 may demodulate wireless data received via an antenna (not shown) to provide the demodulated data to the application processor 820, and may modulate data received from the application processor 820 to provide the modulated data to a remote device (not shown) via the antenna. For example, the modem 810 may be a modem processor that provides wired or wireless communication including GSM, GPRS, WCDMA, HSxPA, and LTE. The application processor 820 may execute applications that provide an internet browser, a three-dimensional map, a game, a video, etc. The nonvolatile memory device 830 may store a boot code for booting the mobile system 800 and a serial number of the volatile memory device 840. For example, the nonvolatile memory device 830 may be implemented by an EEPROM, a flash memory, a PRAM, a RRAM, a NFGM, a PoRAM, a MRAM, a FRAM, etc. The volatile memory device 840 may store data transferred by the modem 810 and data processed by the application processor 820, or may operate as a working memory. For example, the nonvolatile memory device 840 may be implemented by a dynamic random access memory (DRAM), a static random access memory (SRAM), a mobile DRAM, etc. The user interface 850 may include at least one input device, such as a keypad, a touch screen, etc., and at least one output device, such as a display device, a speaker, etc. The power supply 860 may supply the mobile system 800 with power. In some embodiments, the mobile system 800 may further include a camera image processor (CIS).

The application processor 820 may selectively perform training and a test for at least one device (e.g., the volatile memory device 840) using identification information stored in the nonvolatile memory device 830. Accordingly, a boot time of the mobile system 800 may be reduced, and power consumption may be reduced.

In some embodiments, the mobile system 800 and/or components of the mobile system 800 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

FIG. 18 is a block diagram illustrating a server system according to an embodiment of the inventive concept.

FIG. 18 illustrates an example where a server system 900 includes eight hundred racks 910, each rack 910 including twenty five server computers 911. In sum, the server system 900 may include twenty thousand server computers 911.

The server system 900 may employ a power distribution unit (PDU) to stably supply power. When the server system 900 is booted, the PDU may allow the server computers 911 to be booted on a rack basis. Each server computer 911 may be booted without performing memory training and a memory test if a system configuration of the server computer 911 is not changed. Accordingly, since the memory training and the memory test take about 10 seconds, a boot time of each server computer 911 may be reduced by about 10 seconds. Further, when the server system 900 is booted, a boot time of the server system 900 may be reduced by about 8,000 seconds since the server computers 911 are booted on a rack basis. Further, in the server system 900, the power consumption may be reduced since the memory training and the memory test are not performed.

The present inventive concept may be applied to any information handling system, such as a personal computer (PC), a server computer, workstation, a tablet computer, a laptop computer, a mobile phone, a smart phone, a personal digital assistant (PDA), a portable multimedia player (PMP), a digital camera, a digital television, a set-top box, a music player, a portable game console, a navigation device, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of booting an information handling system including a volatile memory device to be selectively tested during a booting operation, the method comprising steps of:
reading current system configuration information from the information handling system;
comparing the current system configuration information with corresponding prestored system configuration information in a nonvolatile memory device; and
selectively performing a test for the volatile memory device according to a result of the comparison, wherein the step of selectively performing a test comprises steps of:
if the current system configuration information does not match the prestored system configuration information, performing a test for checking memory cells of the volatile memory device,
storing test results of the step of performing a test for checking memory cells in the nonvolatile memory device, and
storing the current system configuration information in the nonvolatile memory device.

2. The method of claim 1, wherein the information handling system includes a processor, a board and the volatile memory device as a system configuration.

3. The method of claim 1, wherein the volatile memory device is a memory module of a plurality of dynamic random access memories (DRAMs).

4. The method of claim 1, wherein the volatile memory device is one or more mobile dynamic random access memory (DRAM).

5. The method of claim 3, wherein the memory module includes the nonvolatile memory device of a serial presence detect (SPD) memory.

6. The method of claim 1, wherein the nonvolatile memory device is a basic input output system (BIOS) memory device.

7. The method of claim 5, wherein the step of reading current system configuration information comprises steps of
extracting a current serial number of a processor from the processor;
extracting a current serial number of the board from a BIOS memory device; and
extracting a current serial number of the memory module from the serial presence detect (SPD) memory device.

8. The method of claim 1, wherein the step of performing a test for checking memory cells is performed by built-in self-test logic.

9. The method of claim 1, wherein the step of selectively performing a test further comprises a step of training for optimizing signal integrity of channels connected to the volatile memory device.

10. The method of claim 9, wherein the step of selectively performing a test further comprises a step of applying test results prestored in the nonvolatile memory device to the information handling system without performing the test for checking memory cells and training for optimizing signal integrity of channels if the current system configuration information matches the corresponding stored system configuration information.

11. A method of booting an information handling system including a volatile memory device, the method comprising steps of:
monitoring a triggering condition for testing the volatile memory device;
if the triggering condition is detected, performing a test for checking a failed memory cell in the volatile memory device and training for optimizing signal integrity of channels connected to the volatile memory device; and
if the triggering condition is not detected, skipping the test for checking a failed memory cell and the training for optimizing signal integrity of channels,
wherein the triggering condition is one or more of a system configuration change, a predetermined amount of change in operating temperature, abnormal termination in a previous operation, a predetermined consecutive number of booting operations without testing the volatile memory device.

12. The method of claim 11, wherein the system configuration change is any change of serial numbers of a processor, a board and a volatile memory device at a current booting operation from those stored in a nonvolatile memory device.

13. The method of claim 11, wherein the change of operating temperature is a predetermined amount of difference between operating temperature stored in a nonvolatile memory device and that of current booting operation.

14. The method of claim 11, wherein the abnormal termination is detected by checking a termination flag to indicate how the information handling system terminated in a previous operation.

15. The method of claim 11, further comprising steps of:
comparing a booting count with the predetermined number of consecutive booting operations; and
increasing the booting count by 1 at each time the information handling system is booted without testing the volatile memory device during previous booting operations.

16. An information handling system, comprising:
a board;
a processor mounted on the board;
a volatile memory device mounted on the board, and coupled to the processor; and
a nonvolatile memory device configured to store serial numbers of the board, the processor and the volatile memory device,
wherein the processor is configured to monitor a triggering condition for testing the volatile memory device, and is configured to selectively perform a test for checking memory cells in the volatile memory device and training for optimizing signal integrity of channels connected between the volatile memory device and the processor, and
wherein the triggering condition is one or more of a system configuration change, a predetermined amount of change in operating temperature, abnormal termination in a previous operation, a predetermined consecutive number of booting operations without testing the volatile memory device.

17. The information handling system of the claim 16, wherein the system configuration change is any change of the serial numbers of the processor, the board and the volatile memory device at a current booting operation from those stored in the nonvolatile memory device.
